(19) United States
(12) Patent Application Publication
(10) Pub. No.: US 2026/0006526 A1
(43) Pub. Date: Jan. 1, 2026

(54) Systems and Methods for Conditional Handover and Extended Reality Capacity Enhancements

(71) Applicant: Apple Inc., Cupertino, CA (US)

(72) Inventors: Ralf Rossbach, Munich (DE); Vijendrakumar K Ashiwal, San Jose, CA (US); Vijay Venkataraman, San Jose, CA (US); Yuqin Chen, Beijing (CN); Sandeep K Sunkesala, San Jose, CA (US); Fangli Xu, Beijing (CN); Bharath Jayaram, San Jose, CA (US); Pavan Nuggehalli, San Carlos, CA (US); Peng Cheng, Beijing (CN); Alexander Sirotkin, Hod Hasharon (IL); Haijing Hu, Los Gatos, CA (US); Naveen Kumar R Palle Venkata, San Diego, CA (US); Zhibin Wu, Los Altos, CA (US); Sethuraman Gurumoorthy, San Ramon, CA (US); Sharad Garg, Cupertino, CA (US); Sanjeevi Balasubramanian, San Jose, CA (US); Vijay Gadde, San Jose, CA (US)

(21) Appl. No.: 18/995,026

(22) PCT Filed: Jul. 15, 2022
(86) PCT No.: PCT/CN2022/105936

§ 371 Date: Jan. 15, 2025

(51) Int. Cl. H04W 36/36; H04W 36/00

(52) U.S. Cl. CPC H04W 36/362; H04W 36/0064; H04W 36/00835

(57) ABSTRACT

Apparatuses, systems, and methods for conditional handover (CHO) and extended reality (XR) capacity enhancements. A base station may receive XR traffic characteristics from a user equipment (UE) and/or from a core network. The XR traffic characteristics may be UE specific and/or flow specific. The base station may provide, to one or more target base stations, the XR traffic characteristics as part of a conditional handover request. The XR traffic characteristics may be provided in an information element over an Xn interface. In addition, the base station may receive, from the one or more target base stations, handover request acknowledgments. The handover request acknowledgments may be based, at least in part, on admission control procedures performed based on the XR traffic characteristics. Further, the base station may generate a list of candidate target base stations based on the handover request acknowledgments and provide the list of candidate target base stations to the UE.

### FIELD

The present application relates to wireless communications, and more particularly to systems, apparatuses, and methods for conditional handover (CHO) and extended reality (XR) capacity enhancements, e.g., in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1xRTT, 1xEV-DO, HRPD, eHRPD), IEEE 802.11 (WLAN or Wi-Fi), BLUETOOTH™, etc.

The ever-increasing number of features and functionality introduced in wireless communication devices also creates a continuous need for improvement in both wireless communications and in wireless communication devices. In particular, it is important to ensure the robustness and accuracy of transmitted and received signals through user equipment (UE) devices, e.g., through wireless devices such as cellular phones, base stations and relay stations used in wireless cellular communications.

### SUMMARY

Embodiments relate to wireless communications, and more particularly to apparatuses, systems, and methods for a framework for conditional handover (CHO) and extended reality (XR) capacity enhancements, e.g., in 5G NR systems and beyond.

For example, in some embodiments, a base station may receive XR traffic characteristics from a user equipment (UE) and/or from a radio access network (RAN) and/or a core network. The XR traffic characteristics may be UE specific and/or flow specific. The base station may provide, to one or more target base stations, the XR traffic characteristics as part of a conditional handover request. The XR traffic characteristics may be provided in an information element over an Xn interface. In addition, the base station may receive, from the one or more target base stations, handover request acknowledgments. The handover request acknowledgments may be based, at least in part, on admission control procedures performed based on the XR traffic characteristics. Further, the base station may generate a list of candidate target base stations based on the handover request acknowledgments and provide the list of candidate target base stations to the UE.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, XR devices, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Tables, Figures, and Claims.

### BRIEF DESCRIPTION OF THE DRAWINGS

FIG. 1 illustrates an exemplary (and simplified) wireless communication system, according to some embodiments.

FIG. 2 illustrates an exemplary base station in communication with an exemplary wireless user equipment (UE) device, according to some embodiments.

FIG. 3 illustrates an exemplary block diagram of a UE, according to some embodiments.

FIG. 4 illustrates an exemplary block diagram of a base station, according to some embodiments.

FIG. 5 illustrates an example block diagram of a server according to some embodiments.

FIG. 6 illustrates a diagram of an example of a conditional handover procedure.

FIG. 7 illustrates a block diagram of an example of a method for conditional handover, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC/5GCN: 5G Core Network
IE: Information Element
CE: Control Element
MAC: Medium Access Control
RRC: Radio Resource Control

### Terms

The following is a glossary of terms used in this disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
User Equipment (UE) (or “UE Device”)—any of various types of computer systems devices which are mobile or portable and which performs wireless communications. Examples of UE devices include mobile telephones or smart phones, portable gaming devices, laptops, wearable devices (e.g., smart watch, smart glasses), PDAs, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.
Base Station—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.
Band—The term “band” has the full breadth of its ordinary meaning, and at least includes a section of spectrum (e.g., radio frequency spectrum) in which channels are used or set aside for the same purpose.
Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.
Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

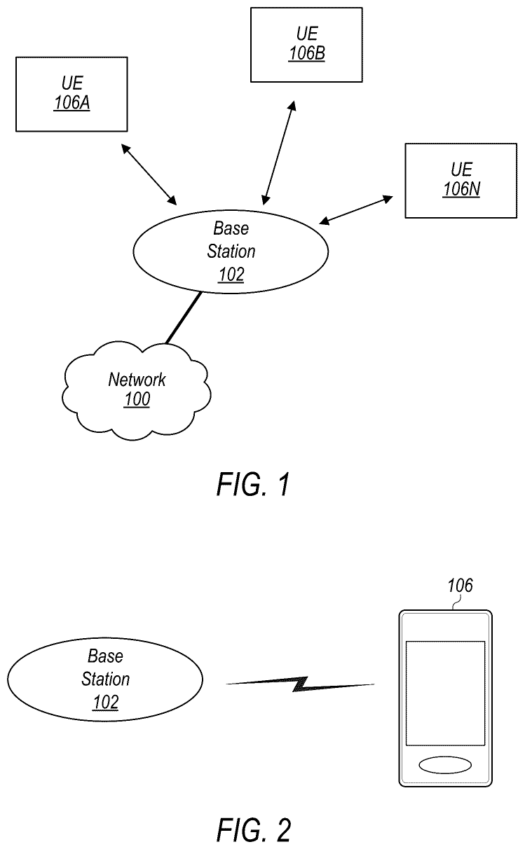

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1xRTT, 1xEV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. The UE 106 may also be configured to be camped on and communicate with multiple base stations concurrently. In some embodiments, the UE 106 may be configured for CHO and XR capacity enhancements, e.g., according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1xRTT (or LTE or NR, or LTE or GSM), and separate radios for communicating using each of Wi-Fi and BLUETOOTH™. Other configurations are also possible.

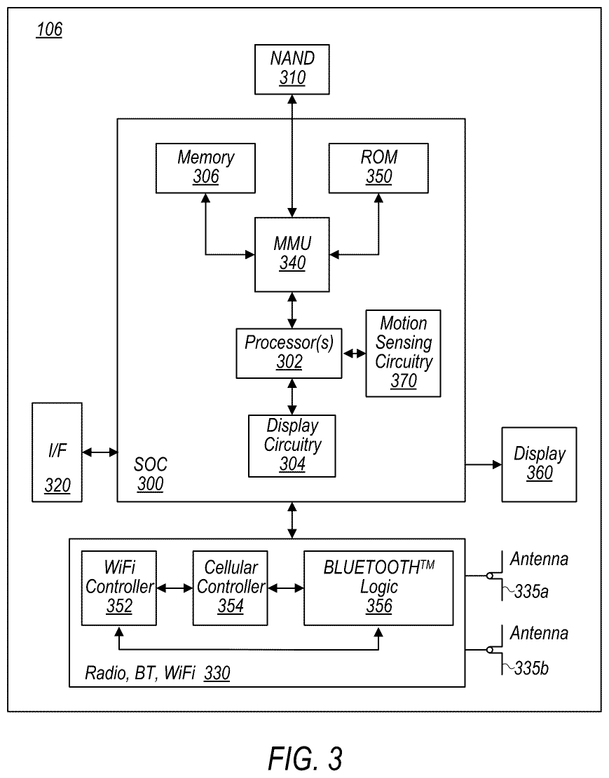

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash memory 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted above, the UE may be configured to communicate wirelessly using multiple wireless communication standards in some embodiments.

The UE 106 may include hardware and software components for implementing CHO and XR capacity enhancements, e.g., according to the various methods described herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, for CHO and XR capacity enhancements, e.g., according to the various methods described herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments may have fewer or more similar controllers for various different RATs that may be implemented in UE device 106.

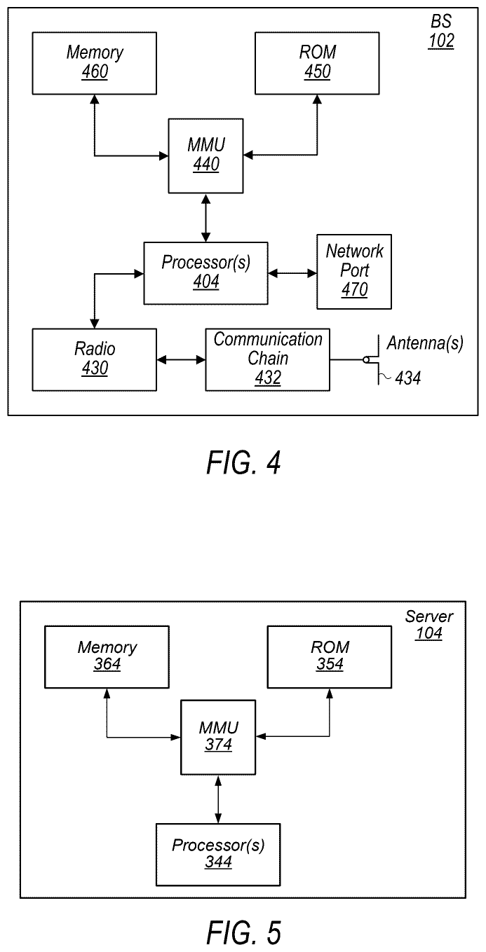

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may also be designed as an access point (AP), in which case network port 470 may be implemented to provide access to a wide area network and/or local area network(s), e.g., it may include at least one Ethernet port, and radio 430 may be designed to communicate according to the Wi-Fi standard. The base station 102 may operate according to the various methods as disclosed herein.

### FIG. 5: Block Diagram of a Server

FIG. 5 illustrates an example block diagram of a server 104, according to some embodiments. It is noted that the server of FIG. 5 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

### CHO and XR Capacity Enhancements

Extended reality (XR) is an umbrella term that covers immersive technologies ranging

from virtual reality (VR) to mixed reality (MR) and augmented reality (AR). In VR, users are totally immersed in a simulated digital environment or a digital replica of reality. In addition, MR includes all variants where virtual and real environments are mixed. Further, AR is a variant of MR, where digital information is overlaid on images of reality viewed through a device. The level of augmentation can vary from a simple information display to the addition of virtual objects and even complete augmentation of the real world. MR can also include variants where real objects are included in the virtual world. XR is expected to improve productivity and convenience for consumers, enterprises, and public institutions in a wide variety of application areas such as entertainment, training, education, remote support, remote control, communications, and virtual meetings. XR can be used in a variety of industry segments, e.g., such as health care, real estate, shopping, transportation, and manufacturing, and VR is already used for gaming both at home and at dedicated venues, for virtual tours in the context of real estate, for education and training purposes, and for remote participation at live events such as concerts and sports.

Hence, there are on-going studies for XR enhancements. For examples, objectives for 3GPP Release 18 enhancements include XR-awareness in a radio access network (RAN), e.g., to identify and understand XR traffic (both uplink and downlink traffic), quality of service (QoS) metrics, and application layer attributes and how such information could aid/enhance XR-specific traffic handling as well as XR-specific power savings. For example, XR-specific power saving techniques to accommodate XR service characteristics (e.g., periodicity, multiple flows, jitter, latency, reliability, and so forth) with a focus on C-DRX and PDCCH monitoring enhancements are of particular interest. In addition, another objective is XR-specific capacity improvements, e.g., to identify mechanisms that provide enhanced (e.g., more efficient) resource allocation and scheduling for XR service characteristics with a focus on semi-persistent scheduling (SPS) and configured grant (CG) enhancements as well as dynamic scheduling and grant enhancements.

In particular, it has been identified that both cell load and cell coverage may impact latency as it pertains to XR traffic. For example, higher block error rates (BLERs) at a cell edge only allow for transmission of smaller transport blocks (TBs) and cause increased transmissions, leading to degraded latency. As another example, higher cell loading leads to longer queues for data which results in scheduling delays. As a further example, handover also generally leads to interruption times.

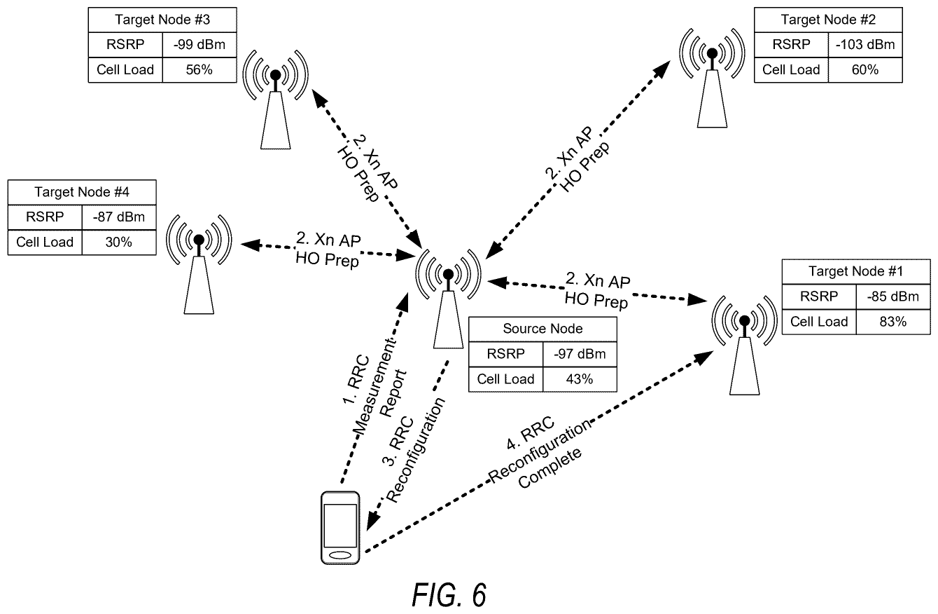

Regarding handover, multiple issues have been identified with conditional handover, e.g., in general as well as in far cell (e.g., cell edge) scenarios. For example, when a UE is configured with multiple conditional handover (CHO) target cells, e.g., as illustrated by FIG. 6. As shown, at (1), a UE may provide an RRC measurement report that triggers a CHO request to a source node. The source node may then make handover preparations at (2), e.g., may request and receive information from target nodes 1, 2, 3, and 4. At (3), the source node may provide a CHO configuration to the UE that includes a CHO execution condition such as, for example, threshold criteria for at least reference signal received power (RSRP). Then, based on the threshold criteria, the UE may execute, at (4), a CHO towards target node #1 which is heavily loaded but may have a marginally better RSRP (and/or other execution/handover conditions) than target node #4. However, target node #4, which has a better RSRP than the current serving cell and is less congested than any other candidate cell, would have been a better target cell for the UE, e.g., because higher cell loading (e.g., in terms of number of UEs served) causes lower grant scheduling rates which increases uplink latency and in turn affects a quality of XR services. Note that XR, due to its challenging key performance indicators (KPIs) (e.g., latency and throughput), consumes a high amount of spectrum and capacity in a cell and, therefore, only a limited number of users can enjoy XR services in the same cell. Further, as the handover procedure involves QOS differentiation of services, the issue becomes more pronounced if multiple users in the target cell use the same QoS Flow Indicator (QFI)/priority, which may become more likely with XR becoming more popular. Ideally, as part of the conditional handover procedure, the serving cell should reserve resources in the target cell; otherwise, if resources cannot be guaranteed, the conditional handover target cell should not be not admitted. However, if the admission control does admit the target cell and the load is high, there is still a higher likelihood for longer queues, thus latency may be affected by the load conditions.

Thus, when conditional handover (CHO) is configured by the network, the UE may decide, based on CHO execution criteria, when to handover and which candidate cell to choose. However, the CHO execution condition currently is only based on RRC configured measurements like RSRP, RSRQ and SNR without taking any loading (cell capacity & currently available resources) into consideration. Additionally, the two main factors that affect latency in a cellular network are cell loading and UE mobility (high BLER). Conditional handover can help reduce latency, especially for latency sensitive applications during mobility but loading still remains a concern. For example, returning to FIG. 6, at (3), the source base station builds the conditional handover command, which is a NR RRC reconfiguration message that contains a list of conditional reconfiguration options plus additional RRC measurement configurations that enables the UE to determine which of the possible target cells is the best fit. Thus, in the example of FIG. 6, the UE ends up selecting target node #1 based only on the RSRP value even though there are better cells (e.g., target node #4) which is still better than serving cell and less congested than any other candidate cells. Such a scenario leads to a poor user experience for latency sensitive application as the latency will increase significantly due to cell congestion.

Additionally, as noted above, increases in BLER cause lower scheduling which increases the uplink latency. Thus, when a UE is in a far cell condition (e.g., at a cell edge or at an edge of a cell), scheduling and radio frequency conditions worsen irrespective of whether the UE has been given a default bearer or a dedicated bearer. Such a situation is even more serious in a stationary far cell condition, e.g., where the UE is stationary and remains in this state until it moves into another cell's coverage and the network triggers a handover. Further, for far cell scenarios, the uplink latency increases significantly as the UE does not receive enough scheduling (only smaller transport blocks can be allocated and retransmissions increase) when uplink BLER increases. Thus, the UE has to be dependent on the network to help move it to a cell which does not have high BLER or has better SNR for uplink data transmission. Additionally, there may be a loss of connection and/or a data stall in such situations which can lead to degraded user experience.

Embodiments described herein provide systems, methods, and mechanisms for conditional handover (CHO) enhancements and extended reality (XR) capacity enhancements. For example, in some embodiments, cell loading conditions may be provided to the UE, e.g., cell loading may be transparent to the UE such that the UE may make an informed selection of a target cell during conditional handover. As another example, in some embodiments, admission control and load management of a serving cell may be enhanced for a conditional handover candidate cells list, e.g., the serving cell may be aware of loading conditions of neighboring cells when generating the conditional handover candidate cell list for the UE. As a further example, in some embodiments, conditional handover conditions may be altered based on load and/or capacity of neighboring cells, e.g., a base station may make heavier loaded cells and/or cells with less capacity less attractive to UEs during a conditional handover. As yet another example, in some embodiments, when a UE is in a far cell condition and conditional handover is configured by the network, the UE may determine when to handover. As a yet further example, in some embodiments, additional conditional handover trigger conditions may be introduced (e.g., for throughput and delay) and, when in a far cell condition, triggering condition offsets and/or multiple triggering events may be specifically configured for stationary UEs.

In some instances, when a UE, such as UE 106, is in a mobility condition and conditional handover is configured for multiple cells, the UE may have the flexibility to choose a target cell (base station) based on both RRC measurements and congestion of target cells. For example, information about cell loading may be available to the UE or may be predicted or acquired by the UE. Thus, the UE may consciously decide to move to a target cell with lower congestion if there are multiple target cells meeting the threshold criteria for handover. In addition, with the aid of cell loading information and latest RRC measurements, the UE may rank target cells in the order of most favorable to least favorable and then select the highest ranked target cell. Such a scheme may improve user experience proactively by selecting a target cell which has more resources and lower latency, especially as compared to remaining on a target cell with high congestion that causes degraded performance, which may become more evident in cases of latency sensitive application.

For example, as part of an XnAP handover request, a source cell (or base station), such as base station 102, may request cell load and/or cell capacity information from target cells. The source cell may then share the cell load and/or cell capacity information with a UE, such as UE 106, as part of RRC reconfiguration messaging. As an example, the source cell may provide such information in a dedicated RRC message, e.g., as an indication when a cell is congested. The indication may be a flag (single bit) indicating that cell loading for a particular cell has crossed a threshold. As another example, multiple fields/multiple quantities (e.g., for loading and/or cell quality) may be provided to the UE via an RRC message. In some instances, determination of a critical threshold for congestion may be determined by the network. For example, a simple percentage (for the entire cell) may not provide any information regarding how many physical resource blocks (PRBs) are left and what latency can be achieved for a specific UE. However, a metric or criteria can be defined that the network can use to detect/evaluate the load. Further, when the load is estimated as high (e.g., above the critical threshold), then the source cell may provide an indication to the UE. Such an indication may be more useful when the network estimates the expected capacity/load specifically for one UE and provides it in a dedicated message, e.g., such as an RRC message. However, cell loading (e.g., capacity utilization) information may (relatively) quickly become outdated, thus, a validity timer may be associated with the cell loading information and/or the network may periodically update a CHO candidate list.

As another example, a source cell (or base station), such as base station 102, may broadcast cell loading information of neighboring cells in system information, e.g., in a system information block. Additionally and/or alternatively, each cell may broadcast its own cell loading in system information, e.g., in a system information block. One advantage of such a scheme is that that cell loading information is always up to date. In addition, such data may be linked to different services and/or different sections of a cell (e.g., SSBs). Further, broadcasting of cell loading information may reduce signaling required for CHO, e.g., if UEs can take such information into account, then the source cell may not need to update the CHO candidate list as often when the cell loading changes and/or when a required capacity can no longer be guaranteed due to higher priority traffic in a cell. Additionally, when a UE is about to start XR traffic (or any other service, such as a data call or service request), the UE may use cell capacity utilization indications as a way to reselect to a better cell before starting the data transfer.

As a further example, a cell (or base station) may include an indication, such as a flag (e.g., binary indication), in a system information broadcast or dedicated signaling to indicate whether the sell is suitable or not suitable for XR traffic. In some instances, e.g., when the indication is included in a broadcast, such information may be used by the UE to bar not suitable cells. In some instances, e.g., when the indication is included in dedicated signaling, such information may be used as decision criteria for a UE as part of CHO. Further, when such XR traffic specific camping info (including cell capacity utilization) is broadcast, a UE may use it not only during CHO but also for initial access when an RRC connection is triggered by an XR service request, for example, to reselect to a better cell before starting the data transfer.

As yet another example, a UE, such as UE 106, may access a crowd sourced and/or artificial intelligence/machine learning driven database which may maintain, for a given location, some observed key performance indicators (KPIs) (e.g., such as average latency, average throughput, scheduling rates, BLER, and so forth) based on a (variable and/or configurable) moving average time window. The database may be used by the UE as a reference for comparison. Thus, the UE may utilize the database to determine how congested target cells may typically be during a particular time of day and use such information as part of a target cell selection during CHO. In some instances, the UE may use latency and/or scheduling rates together with a statistic of earlier data for a specific time of the day and a location. For example, when data indicates low scheduling rates for one cell, then the UE may avoid the cell and/or ignore the cell as part of the CHO. In some instances, a UE's evaluation of history data may take a last time when a network configuration changed into account, e.g., to restart or reset the window. In some instances, the UE may also take into account BLER, how often a required QoS was missed in a cell, and/or other QoS related parameters as measured by the UE internally.

As a further example, a UE may rank target cells, e.g., add a weighting factor and/or an ‘estimated success probability’ to each target cell and rank target cells accordingly. Acquisition of cell loading and/or how to rank CHO candidate cells may be based on any of the above-described examples and/or left to UE implementation. In some instances, the UE may also take into account BLER, how often a required QoS was missed in a cell, and/or other QoS related parameters as measured by the UE internally.

In some instances, XR traffic characteristics may be used as input into a conditional handover decision at a serving (or source) cell, such as base station 102, and/or as input to an admission control function at a target cell, such as base station 102. For example, a serving cell may provide XR traffic characteristics as part of a handover request (e.g., via an information element). As another example, the UE or core network may provide a serving cell with specific and/or updated XR traffic characteristics for a flow or a UE. The serving cell may then take these UE specific data into account when populating a traffic characteristics information element. Note that XR traffic characteristics may be included in other Xn procedures where XR traffic characteristics are used in a similar manner, e.g., XR traffic characteristic sharing is not limited to CHO. Further, a target base station may perform admission control by taking into account the QFI, XR traffic characteristics, and/or currently available resources. As a result, radio resources may be budgeted for accordingly by taking into account actual demand more appropriately. Note further that XR traffic characteristics may also be shared via F1 and E1 interfaces, e.g., for UE Context Setup/Modification (over F1, and it can further include a CHO) or Bearer Context Modification (over E1). In other words, any procedure using a TSC Traffic Characteristics IE may be modified to include XR traffic characteristics.

For example, at an Xn/F1/E1 interface, a load management function exists and a Resource Status Reporting procedure can be used for reporting of load measurements. This includes information about available capacity in a cell. Thus, in some instances, a base station (e.g., source cell) may use load measurements during a CHO decision and reserve radio resources ‘once and for all’ at a target cell until the CHO is cancelled. In some instances, a base station may update a CHO candidate list at a later time. Thus, when availability of radio resources changes, the base station may re-evaluate a CHO decision and may update a CHO candidate list. Hence, a UE may be provided with an updated CHO in a new RRC reconfiguration when a load management function indicates that sufficient resources are no longer available at a target cell. Note that XR traffic characteristics may be used as input to the load management function at the base station. For example, with respect to XR traffic characteristics being provided as input to the load management function:
a) a source cell may send XR traffic characteristics to the target cell;
b) the target cell may admit the UE, e.g., based on the XR traffic characteristics;
c) a candidate CHO list may be configured to the UE e.g., based on the XR traffic characteristics; and/or
d) if, at some point in time, the target cell can no longer satisfy the XR requirements of the admitted (but not yet handed over) UE, the target cell may proactively indicate such information to the source cell and the source cell may remove the target cell from the CHO candidate list (new part).

In some instances, in order to account for cell loading (e.g., an amount of radio resources available), a serving cell, such as base station 102, may make a conditional handover towards a heavily loaded target cell less attractive. For example, the serving cell (e.g., the cell providing the conditional handover configuration to the UE) may use the load/capacity indications from target cells to apply a weight factor (or a negative offset) to RSRP/RSRQ/SINR values as part of the conditional handover trigger conditions that are provided to the UE, e.g., by slightly making congested cells less attractive as a handover target. Such a scheme may be transparent to the UE and/or the UE may be provided with additional CHO offsets to RSRP/RSRQ/SINR in an RRC reconfiguration message which are to be applied in addition to existing criteria. As another example, the network may assign a priority level (or another type of weighting) as an optional parameter to each candidate target cell in a target cell list. Thus, each conditional handover candidate cell may be assigned a priority that a UE can evaluate. The priority may indicate a load balancing hint or assistance to the UE for the selection. As a further example, the network may require a UE to process a CHO candidate list in a particular order, so that, for example, cells with more favorite loading conditions (e.g., shorter queues and/or achievable QoS based on resource availability) are considered first. In such instances, there may not be a need for a load specific parameter, however, the network may provide a conditional handover preference among the target cells as to what is a preferred target.

In some instances, when a UE, such as UE 106, is in a far cell condition and conditional handover is configured by the network, the UE may determine when to handover to a target cell. Such a scheme may allow the UE to make a decision based on the conditional handover configuration to move to a better cell, e.g., to help enable the UE to move to a cell with better radio frequency conditions. The UE may select a conditional handover target cell based on local measurements. The decision may be based on UE measurement history (e.g., the UE may autonomously decide to move to a higher capacity/better cell based on previous history or measurements) or using an inbuilt database. Alternatively and/or in addition, the decision may be based on BLER and/or SINR. For example, a reason for latency spikes when a UE is in a stationary far cell condition is because of an increase in BLER even in decent RSRP conditions. Thus, instead of relying on multiple additional triggering events configured by the network (which are based on RRC measurements) the UE may benefit from inclusion of downlink BLER calculated by the UE on the source cell as one of the CHO criteria. As an example, if downlink BLER is greater than a threshold and the source cell RSRP is below another threshold and the UE determines a candidate target cell has an RSRP better than the source cell but within a range of the source cell such that CHO trigger conditions are not met, an offset may be applied to trigger a CHO. Likewise, other observed, recorded and/or otherwise available data about other cell quality indicators such as uplink BLER, RSRQ, SINR, a number of retransmissions, and so forth may be considered by the UE as criteria to autonomously decide when to move to another cell or execute a CHO. As another example, additional CHO trigger conditions may be considered, such as measurement and/or measurement windows for throughput and delay, e.g., a CHO may be triggered when a throughput or delay crosses a respective threshold. As a further example, when in a far cell condition, when a CHO trigger is not met when a UE is stationary in a far cell and/or cell edge condition, the UE may use an RSRP offset to trigger a CHO. For example, a UE may use offsets specifically applicable to stationary UEs at a cell edge (e.g., as part of an RRC condTriggerConfig and/or an RRC condExecutionCond) and/or a separate time to trigger to trigger a CHO. As another example, when in a far cell condition, when a CHO trigger is not met when a UE is stationary in a far cell and/or cell edge condition, the network may provide multiple condExecutionCond to the UE via RRC messaging.

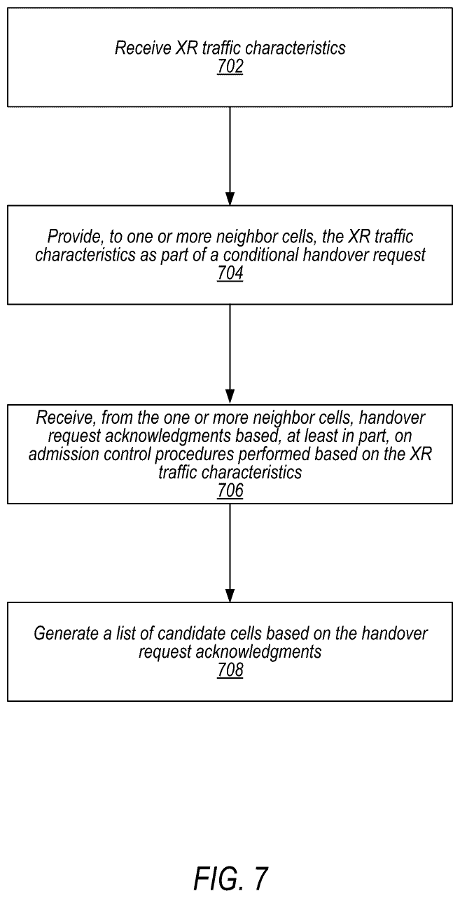

FIG. 7 illustrates a block diagram of an example of a method for conditional handover, according to some embodiments. The method shown in FIG. 7 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 702, a base station, such as base station 102, may receive extended reality, XR, traffic characteristics. The base station may be considered a source base station, at least in some instances. The XR traffic characteristics may be received, for example, from a user equipment (UE), such as UE 106, a radio access network (RAN) (e.g., an entity of the RAN) or from a core network. The XR traffic characteristics may be UE specific and/or flow specific. In some instances, the XR traffic characteristics may include any, any combination of, and/or all of (e.g., at least one of and/or one or more of) traffic arrival pattern, burst size, jitter, typical periodicity, priority of a flow, downlink data rate ranges, uplink data rate ranges, a protocol data unit (PDU) set delay budget in downlink (e.g., a maximum tolerable or threshold PDU set delay budget in downlink), a PDU set delay budget in uplink (e.g., a maximum tolerable or threshold PDU set delay budget in uplink), a PDU set error rate (e.g., a maximum tolerable or threshold PDU set error rate), a round trip time (e.g., a maximum tolerable or threshold round trip time), an Internet Protocol (IP) level downlink packet size, an IP level uplink packet size, IP level downlink temporal characteristics, IP level uplink temporal characteristics, and/or any other parameter indicative and/or informative of XR traffic characteristics.

At 704, the base station may provide, to one or more neighbor cells (e.g., one or more target cells and/or one or more target base stations), the XR traffic characteristics as part of a conditional handover request. The XR traffic characteristics may be provided over an Xn interface. In some instances, the XR traffic characteristics may be provided via an information element. The information element may be a Time Sensitive Communication (TSC) Traffic Characteristics information element, e.g., as defined in 3GPP standards, at least in some instances. In other words, the XR traffic characteristics may be included as a parameter in the TSC Traffic Characteristics information element. In some instances, the information element may be distinct from a TSC Traffic Characteristics information element as defined in 3GPP standards.

At 706, the base station may receive, from the one or more neighbor cells, handover request acknowledgments. The handover request acknowledgments may be based, at least in part, on admission control procedures performed based on and/or taking into account the XR traffic characteristics.

At 708, the base station may generate a list of target candidate cells (e.g., a list of candidate target base stations) based on the handover request acknowledgments.

In some instances, the base station may provide, to the UE, the list of target candidate cells. The list of target candidate cells may be provided via a radio resource control (RRC) reconfiguration message. In some instances, the base station may also provide and/or providing the list of target candidate cells may include the base station providing a conditional handover configuration to the UE. The conditional handover configuration may include trigger conditions. The trigger conditions may include threshold values for any, any combination of, and/or all of (e.g., at least one of and/or one or more of) reference signal (RS) received power (RSRP), RS received quality (RSRQ), and/or signal to interference plus noise ratio (SINR).

In some instances, the base station may apply a weighting factor and/or a negative offset to one or more of and/or at least one of the trigger conditions. The weighting factor and/or the negative offset may be based, at least in part, on load indications and/or capacity indications received from the one or more neighbor cells.

In some instances, the base station may assign, to each of the one or more neighbor cells, a priority level based on loading conditions of the one or more neighbor cells. For example, higher priority levels may be assigned to neighboring cells with lower loading conditions (e.g., more favorable loading conditions for XR traffic) and lower priority levels may be assigned to neighboring cells with higher loading conditions (e.g., less favorable loading conditions for XR traffic), thereby dissuading the UE from selection of neighboring cells with higher loading conditions. The conditional handover configuration may include indications of the assigned priority levels, at least in some instances.

In some instances, the base station may assign, to each of the one or more neighbor cells, a processing preference based on loading conditions of the one or more neighbor cells. For example, neighboring cells with lower loading conditions (e.g., more favorable loading conditions for XR traffic) are to be processed by the UE prior to neighboring cells with higher loading conditions (e.g., less favorable loading conditions for XR traffic). The conditional handover configuration may include an indication of the processing order of the neighboring cells, at least in some instances.

In some instances, the base station may reserve, based on load measurements, radio resources at one of the one or more neighbor cells. The radio resources may be reserved until a conditional handover is cancelled.

In some instances, the base station may determine that availability of radio resources at one of the one or more neighbor cells has changed. In such instances, the base station may update the list of target candidate cells based on the change in radio resources, thereby generating an updated list of target candidate cells. In some instances, the base station may provide the updated list of target candidate cells to the UE. The updated list of target candidate cells may be provided to the UE via an RRC reconfiguration message.

In some instances, the base station may request, from the one or more neighbor cells, cell load information and/or cell capacity information. Further, the base station may provide, to the UE, the cell load information and/or the cell capacity information for the one or more neighbor cells. In some instances, the base station may provide, to the UE, an associated expiration time for the cell load information and/or the cell capacity information. In some instances, the base station may provide the cell load information and/or the cell capacity to the UE via an RRC message. In some instances, the base station may provide the cell load information and/or the cell capacity information via a broadcast message.

In some instances, the base station may broadcast cell load information and/or cell capacity information. In some instances, the cell load information and/or cell capacity information may be indicated via a binary indicator. The binary indicator may indicate whether or not the base station is suitable for XR traffic, at least in some instances.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for conditional handover, comprising:
receiving extended reality (XR), traffic characteristics;
providing, to one or more target base stations, the XR traffic characteristics as part of a conditional handover;
receiving, from the one or more target base stations, handover request acknowledgments, wherein the handover request acknowledgments are based, at least in part, on admission control procedures performed based on the XR traffic characteristics; and
generating a list of candidate target base stations based on the handover request acknowledgments.

2. The method of claim 1,
wherein the XR traffic characteristics are provided over an Xn interface.

3. The method of claim 1,
wherein the XR traffic characteristics are provided via an information element.

4. The method of claim 1,
wherein the XR traffic characteristics are received from a user equipment (UE).

5. The method of claim 4,
wherein the XR traffic characteristics are flow specific.

6. The method of claim 1,
wherein the XR traffic characteristics are received from a core network.

7. The method of claim 3,
wherein the information element comprises a Time Sensitive Communication (TSC), Traffic Characteristics information element.

8. The method of claim 6,
wherein the XR traffic characteristics are user equipment (UE), specific or flow specific.

9.-31. (canceled)

32. A baseband processor, comprising:
a memory; and
at least one processor in communication with the memory and configured to:
receive extended reality (XR) traffic characteristics;
provide, to one or more target base stations, the XR traffic characteristics as part of a conditional handover;
receive, from the one or more target base stations, handover request acknowledgments, wherein the handover request acknowledgments are based, at least in part, on admission control procedures performed based on the XR traffic characteristics; and
generate a list of candidate target base stations based on the handover request acknowledgments.

33. The baseband processor of claim 32,
wherein the at least one processor is further configured to:
provide, to a user equipment (UE), the list of candidate target base stations.

34. The baseband processor of claim 33,
wherein the list of candidate target base stations is provided via a radio resource control, RRC, reconfiguration message.

35. The baseband processor of claim 33,
wherein to provide, to the UE, the list of candidate target base stations, the at least one processor is further configured to provide a conditional handover configuration to the UE.

36. The baseband processor of claim 35,
wherein the conditional handover configuration comprises trigger conditions, wherein the trigger conditions include threshold values for one or more of:
reference signal (RS) received power (RSRP);
RS received quality (RSRQ); or
signal to interference plus noise ratio (SINR).

37. The baseband processor of claim 36,
wherein the at least one processor is further configured to:
apply a weighting factor or a negative offset to one or more of the trigger conditions, wherein the weighting factor or the negative offset is based, at least in part, on load indications or capacity indications received from one or more neighbor cells.

38. The baseband processor of claim 35,
wherein the at least one processor is further configured to:
assign, to each of the one or more neighbor cells, a priority level based on loading conditions of the one or more target base stations, wherein higher priority levels are assigned to neighboring cells with lower loading conditions and lower priority levels are assigned to neighboring cells with higher loading conditions, thereby dissuading the UE from selection of neighboring cells with higher loading conditions, and wherein the conditional handover configuration includes indications of the assigned priority levels.

39. The baseband processor of claim 35,
wherein the at least one processor is further configured to:
assign, to each of the one or more target base stations, a processing preference based on loading conditions of the one or more target base stations, wherein neighboring cells with lower loading conditions are to be processed by the UE prior to neighboring cells with higher loading conditions, and wherein the conditional handover configuration includes an indication of the processing order of the neighboring cells.

40. A non-transitory computer readable memory medium comprising instructions executable by a processor to:
receive extended reality (XR) traffic characteristics;
provide, to one or more target base stations, the XR traffic characteristics as part of a conditional handover;
receive, from the one or more target base stations, handover request acknowledgments, wherein the handover request acknowledgments are based, at least in part, on admission control procedures performed based on the XR traffic characteristics; and
generate a list of candidate target base stations based on the handover request acknowledgments.

41. The non-transitory computer readable memory medium of claim 40,
wherein the instructions are further executable by the processor to:
reserve, based on load measurements, radio resources at one of the one or more target base stations.

42. The non-transitory computer readable memory medium of claim 41,
wherein the radio resources are reserved until a conditional handover is cancelled.

43. The non-transitory computer readable memory medium of claim 40,
wherein the instructions are further executable by the processor to:
determine that availability of radio resources at one of the one or more target base stations has changed; and
update the list of candidate target base stations based on the change in radio resources, thereby generating an updated list of candidate target base stations.
